(19) United States
(12) Patent Application Publication
(10) Pub. No.: US 2008/0236389 A1
(43) Pub. Date: Oct. 2, 2008

(54) Impregnated Monoliths

(75) Inventors: William B. Leedy, Mooresville, NC (US); Jack F. Eichelsbacher, Hilton Head, SC (US); Thomas H. Shelton, Roanoke, VA (US)

Correspondence Address: MEADWESTVACO CORPORATION, 1021 MAIN CAMPUS DRIVE, CENTENNIAL CAMPUS, RALEIGH, NC, 27606, US

(73) Assignee: Mead Westvaco Corporation, Glen Allen, VA (US)

(21) Appl. No.: 12/067,388

(22) PCT Filed: Apr. 18, 2007
(86) PCT No.: PCT/US07/66865

§ 371 Date: Mar. 19, 2008

Related U.S. Application Data
(60) Provisional application No. 60/745,477, filed on Apr. 24, 2006.

(51) Int. Cl. B01D 53/047; B01D 53/02; B32B 3/12; B32B 3/26; B01D 53/04

(52) U.S. Cl. 95/95; 96/135; 428/305.5; 95/90; 95/137; 95/143; 95/129; 95/136; 95/135; 95/132; 95/131; 428/116

(57) ABSTRACT

The present invention relates to adsorbent honeycomb monoliths and other porous monoliths impregnated with alkaline and/or caustic salts of alkaline metal or alkaline earth metal. The impregnated monoliths have high adsorption capacity and low flow resistance, yet with minimized flammability, suitable for use in removal of acidic, malodorous and/or harmful gases.

This non-provisional application relies on the filing date of provisional U.S. Application Ser. No. 60/745,477 filed on Apr. 24, 2006, which is incorporated herein by reference, having been filed within twelve (12) months thereof, and priority thereto is claimed under 35 USC § 1.19(e).

### BACKGROUND OF THE INVENTION

Porous adsorptive materials have been used for removal of impurities from fluid streams. In particular, activated carbon has been used for removal of impurities and recovery of useful substances from liquids and gases because of its high adsorptive capacity. Generally, “activation” refers to any of the various processes by which the pore structure is enhanced. Common carbon sources include resin wastes, coal, coal coke, petroleum coke, lignite, polymeric materials, lignocellulosic materials such as pulp and paper, residues from pulp production, wood, nut shell, kernel, fruit pit, petroleum, carbohydrates, and bone. Typical activation processes involve treatment of carbon sources either thermally with oxidizing agent such as steam, carbon dioxide, metal chloride (e.g., zinc chloride), phosphoric acid, or potassium sulfide, at high temperatures. Activation creates a high surface area and in turn imparts high adsorptive capability to the structure. U.S. Pat. No. RE 31,093 teaches a chemical activation of wood-based carbon with phosphoric acid to improve the carbon's decolorizing and gas adsorbing abilities. U.S. Pat. No. 4,769,359 teaches a method of producing activated carbon by treating coal cokes and chars, brown coals or lignite with a mixture of NaOH and KOH and heating to at least 500° C. in an inert atmosphere.

Activated carbon has been widely used as an adsorbent for removal malodorous and harmful gaseous components. Examples of malodorous or harmful gases include sulfur-containing compounds such as hydrogen sulfide, mercaptan, and sulfide; nitrogen-containing compounds such as ammonia and amines; aldehydes; acidic gas such as sulfuric acid and carboxylic acids; hydrocarbons; and carbon monoxide. Gas containing malodorous and harmful gaseous components is typically passed through a bed of granular or fibrous activated carbon adsorbent. When granular or fibrous activated carbon is used as an adsorbent, the bed has high flow resistance and consequently consumes significantly large amount of operation energy. Furthermore, the malodorous and harmful gaseous components usually present in very low concentrations in the gas stream that, with the above-mentioned activated carbon alone, it is difficult to selectively adsorb and remove all of these malodorous and harmful components. The rate and amount of elimination are often meager. Accordingly, a large quantity of activated carbon is required for the adsorption/removal of malodorous and harmful components.

Manufacturing plants often emit corrosive gases, such as hydride and acidic gases, which pose considerable health and environmental hazards in addition to jeopardizing the integrity of exhaust systems. Many emission control abatement systems have been used for such toxic, flammable, and corrosive gas. The manufacture of semiconductors commonly emits hazardous gases such as HCl, HF, BF₃, AsH₃, PH₃ and SiF₄ gases. Other hazardous and/or odorous gases include, but are not limited to, chlorine and fluorine.

U.S. Pat. No. 4,215,096 discloses that pelletized activated carbon impregnated with sodium hydroxide (NaOH) at a loading level of 0.1-20%, preferably 0.5-15%, by weight of NaOH. The impregnated activated carbon has an improved adsorption capacity for H₂S gas compared to the non-impregnated activated carbon. However, such improvement has limited success for a commercial use. The pore structure of activated carbon is somewhat filled with the impregnant, thereby lowering the adsorption capacity. The impregnated pelletized carbon has high flow resistance, due to high pressure drop through a pelletized carbon bed; thus it requires relatively high operation energy. Furthermore, pelletized carbons impregnated with caustic NaOH are susceptible to uncontrolled thermal excursions, resulting from a suppressed combustion temperature and exothermic reactions caused by the caustic impregnation.

U.S. Pat. No. 5,356,849 and U.S. Pat. No. 5,494,869 discloses catalytic carbons that overcome the deficiencies associated with the caustic impregnated activated carbons. The catalytic carbons do not exhibit the reduced combustion temperature that the caustic impregnated activated carbons experience. However, the H₂S adsorption capacity of the catalytic carbon is generally low, thus it is too costly for a commercial use.

U.S. Pat. No. 6,858,192 discloses an activated carbon impregnated with metal oxides at loading level of 3-15% by weight of metal oxide. A mixture of ground powder or granular carbonaceous material and metal oxide is extruded into 4 mm-diameter strands, carbonized, and finally activated. The resulting impregnated activated carbon has an improved H₂S adsorption capacity over the caustic impregnated activated carbon, the catalytic carbon and obviously, a typical activated carbon. Unfortunately, the process for preparing this high hydrogen sulfide capacity carbon leaves significant amounts of the active agent unavailable for a reaction.

Although using activated carbon impregnated with alkaline salts as adsorbent for acidic malodorous and/or hazardous gas seems attractive, there are many limitations especially when the adsorbent is desired to have high adsorption capacity, high impregnant loading, and low flow resistance. When activated carbon is impregnated with alkaline chemicals, such as for removal of sulfur-containing gaseous compounds, the ignition point of the carbon is depressed. Therefore, it is dangerous to use such an alkali-supporting activated carbon in an inhabited area. An attempt to decrease flammability by incorporating a flame retardant additive to such activated carbon leads to a reduction in the amount of adsorption per unit specific surface area, thereby minimizing the adsorption capacity.

It is, therefore, an object of the invention to provide adsorbent honeycomb monoliths impregnated with alkaline and/or caustic chemicals, having improved flame retardant and high efficiency for removing contaminants in a treated stream.

It is another object of the invention to provide adsorbent honeycomb monoliths impregnated with alkaline and/or caustic chemicals having low flow resistance, yet high adsorption capacity.

It is yet another object of the invention to provide adsorbent honeycomb monoliths impregnated with alkaline and/or caustic chemicals, having high efficiency in removing acidic and/or malodorous gaseous contaminants in a gas stream.

It is a further object of the invention to provide an apparatus for removal acidic gaseous contaminants using at least one adsorbent honeycomb monolith impregnated with alkaline chemicals and/or caustic as an adsorbent that presents low flammability and high adsorption capacity, yet at low flow resistance.

It is yet a further object of the invention to provide impregnated adsorbent honeycomb monoliths suitable for removing malodorous and harmful contaminants.

Other objects, features and advantages of the present invention will be set forth in part in the description which follows, and in part will be obvious from the description or may be learned by practice of the invention.

### SUMMARY OF THE INVENTION

The subject matter of the present invention relates to adsorbent honeycomb monoliths and other porous monoliths impregnated with alkaline and/or caustic salts of alkaline metal or alkaline earth metal. The impregnated monoliths have high adsorption capacity and low flow resistance, yet with minimized flammability, suitable for use in removal of acidic, malodorous and/or harmful gases.

### DESCRIPTION OF THE DRAWING

FIG. 1 is a graph showing pressure drop of adsorbent beds containing different adsorbents and at different flow velocity: activated carbon monolith impregnated with 10% Na₂CO₃ solution and activated carbon pellet impregnated with 10% Na₂CO₃ solution.

### DETAILED DESCRIPTION OF THE INVENTION

The present invention now will be described more fully hereinafter, but not all embodiments of the invention are shown. Indeed, the invention may be embodied in many different forms and should not be construed as limited to the embodiments set forth herein; rather, these embodiments are provided so that this disclosure will satisfy applicable legal requirements. Based on the nature or type of impregnant, the invention adsorbent honeycomb monolith may have alternative and multiple uses.

The adsorbent honeycomb monolith suitable for use in the present invention may include, but are not limited to, activated carbon, silica, zeolite, alumina, silver, sintered metal, zirconia, titania, and other metal oxides, and combinations thereof. The activated carbon may be derived from various carbon precursors. These include, but are not limited to, wood, wood dust, wood flour, cotton linters, peat, coal, coconut, lignite, carbohydrates, petroleum pitch, petroleum coke, coal tar pitch, fruit pits, fruit stones, nut shells, nut pits, sawdust, palm, vegetables such as rice hull or straw, synthetic polymer, natural polymer, lignocellulosic material, and combinations thereof. Furthermore, the activated carbon may be produced using a variety of processes including, but are not limited to, chemical activation, thermal activation, and combinations thereof.

Impregnants suitable for use in the present invention may be alkaline salt of metal Group IA (alkaline metal) and/or metal Group IIA (alkaline earth metal) capable of removing malordorous and harmful gaseous compounds. These alkaline salts may include, but are not limited to, hydroxide salt, carbonate salt, hydrogen carbonate salt, chlorides, bromides, and fluorides, nitrate, sulfate, chlorate, carboxylate, and combinations thereof. Examples of these salts include, but are not limited to, LiOH, NaOH, KOH, Ca(OH)₂, Mg(OH)₂, Sr(OH)₂, Ba(OH)₂, Li₂CO₃, Na₂CO₃, K₂CO₃, CaCO₃, MgCO₃, LiHCO₃, KHCO₃, and NaHCO₃. This list is not intended to be limiting, and those skilled in the art will recognize that other salts may be used in the present invention. Additionally, the impregnants may be one type of metal salt or a combination of types of metal salts.

In one embodiment of the present invention, the porous monolith adsorbent may be impregnated with chemicals capable of removing war gases. Suitable adsorbents for such application include, but are not limited to, Rankinite, Rankinite A, silver, mercury, iodic Acid, any one of a variety of commonly known whetlerites, or mixtures of whetlerites. Examples of whetlerites include, but are not limited to, Type A, Type B, Type AS, Type D, Type A impregnated with Hexamine, Type A impregnated with sodium thiocyanate, Type ASM, Type ASV, Type ASMT, Type ASC, Type ASCM, Type ASVT, Type ASC-1, Type Bamebey-Cheney, Type ASCP, Type ASCPi, Type E11, Type PCI, Type ASZM, Type ASZM-TEDA, and Type ASC-TEDA. Examples of war gas include, but are not limited to, acyl chlorides, amines, ammonia, arsine, carbon monoxide, chloropicrin, cyanogen chloride, hydrogen cyanide, fluorides, fluorophosphates, mustard gas, nitrogen dioxide, phosgene, sulfur dioxide, Saran, VX, and DMMP.

The adsorbent honeycomb monolith structure of the invention impregnated carbon may be an extruded honeycomb with parallel cell passages, layered sheets with parallel passages, jelly-rolled sheets with parallel cell passages, bound aggregates of particulates with randomly distributed voidages for vapor flow, and combinations thereof. Additionally, the monolith may have geometrically uniform or non-uniform flow channels of similar, different, or random widths.

The adsorbent honeycomb monolith of the present invention may include a material that supports in the forming and/or retaining of its monolith shape. Examples of such supporting materials include, but are not limited to, ceramic material such as clay and cordierite, flux, glass ceramic, metal, mullite, corrugated paper, organic fibers, resin binder, talc, alumina powder, magnesia powder, silica powder, kaolin powder, sinterable inorganic powder, fusible glass powder, and combinations thereof. When the supporting materials used for the monolith structure is ceramic-based material, the monolith itself may also act as a heat sink to moderate the temperature increases during adsorption cycle and as a heat source to moderate the temperature decreases during regeneration cycle to further enhance the cycle efficiency. Additionally, ceramic-based material may contribute strength and stability to the monolith.

In one embodiment, the adsorbent honeycomb monolith is produced by shaping a mixture of activated carbon and aforementioned supporting material(s) into monolith structure. The mixture may be extruded into monolith structure as described in U.S. Pat. Nos. 5,914,294; 6,171,373; and 6,284,705. Additionally, the mixture may be formed into monolith structure through pressure molding as described in U.S. Pat. No. 4,518,704. After formed into the monolith structure, the mixture may be heated to a high temperature in an inert or oxidizing atmosphere to form the final product. When ceramic is used as a binder, the invention impregnated monolith has an excellent flame retardant and heat dissipation that is advantageous as catalyst support for high loadings of metal catalyst.

In another embodiment, an adsorbent honeycomb monolith is produced by impregnating or depositing carbon precursor onto a monolithic structure made of the aforementioned supporting material(s), curing and/or carbonizing the carbon precursor to form a uniform adherent continuous coating of carbon on the monolith structure, and finally activating the carbon as described in the U.S. Pat. Nos. 5,750,026 and 6,372,289.

In yet another embodiment, an adsorbent honeycomb monolith is produced by impregnating or depositing activated carbon onto a monolithic structure made of the aforementioned supporting material(s). For example, U.S. Pat. No. 4,992,319 describes a method of producing activated carbon monolith by dipping an inorganic fiber made paper in a suspension of fine particulate activated carbon and a binder or coating the suspension over the inorganic fiber made paper; drying the paper so that the activated carbon will fill the voids between the fibers in the paper; superposing sheets of the activated carbon filled paper alternately with corrugated sheets of the same paper; and bonding the individual sheets together with an adhesive to form a monolith structure.

In one embodiment of the present invention, an activated carbon monolith is formed, and then impregnated with alkaline salts. The activated carbon monolith is impregnated with a solution or dispersion of the alkaline salt in water or an organic solvent such as an alcohol. Any known impregnation techniques may be used in the present invention. These include, but are not limited to, dipping, spraying, and blowing. Furthermore, the impregnated monolith may or may not be completely dried prior to its use.

In another embodiment of the present invention, the activated carbon is impregnated or mixed with the alkaline salt, and then shaped into monolith form or deposited onto the monolith structure.

In yet another embodiment of the present invention, the carbonaceous material is mixed with the alkaline salt, then molded into a monolith shape or deposited onto the monolith structure, and finally activated.

The impregnated activated carbon monolith of the present invention may be regenerated by washing the spent activated carbon monolith and then redepositing the reactive compound using the same techniques for post-monolith formation impregnation.

The impregnated activated carbon monolith of the present invention was used as an adsorbent for the removal of H₂S in a gas stream, and its performance was compared to those of impregnated activated carbon pellets having the same alkaline salt impregnant and at the same loading level. The amount of H₂S removed (in units of lbs H₂S removed/ft³ of an adsorbent bed) from a flowing gas stream was determined gas analyzer Eagle Model No 72-5103RK-01. The amount of H₂S removed was calculated based on the total air flow through the beds up to the point when the complete breakthrough was observed (i.e., 1 ppm H₂S in the outlet). The test was set-up such that the gas flow rate (in units of cfm) was similar when each investigated adsorbent was used. The inlet air flow rate was 6.5 cfm, and the inlet H₂S concentration was 1 ppm. At these conditions the velocity through the pellet bed was 75 ft/min and the velocity through the monolith was 450 ft/min. Under these conditions, the pressure drop for the monolith was 1.8 inches H₂O/ft of an adsorbent bed. This is equivalent to, or better than, the pressure drop typically found in the pellet beds, even though the air flow velocity through the monolith was 6 times greater. The impregnation of the monolith and the pellets were conducted by the immersion into a salt bath at elevated temperatures (140 to 160 F) for 15 minutes to 2 hours.

The impregnated monoliths were 1.6 inches in diameter and 4 inches in length, and had a cell density of 200-250 cells/in². Four of them were placed in a housing, stacked vertically one on top of the other with a 1 inch-gap between each monolith to allow for pressure and H₂S concentration measurements. Each monolith was secured with an o-ring seal to prevent by-pass. The housing was placed in-line in a H₂S pilot column test apparatus. Concentrations were measured on a regular basis of the feed gas and at points downstream of each monolith element. Relative humidity was also constantly monitored.

The impregnated pellets were housed in a column having 4 inches in diameter and 18 inches in length. The concentrations of H₂S were measured on a regular basis of the feed gas and at regular intervals down the depth of the bed. Relative humidity was also constantly monitored.

Impregnated Activated Carbon: Monolith vs Pellet

The activated carbon monolith was impregnated with 10% Na₂CO₃ solution, which corresponded to about 7% by weight of salt based on total weight of the impregnated monolith. The activated carbon pellet was impregnated with 10% Na₂CO₃ solution, which corresponded to about 8% by weight of salt based on total weight of the impregnated pellet. At 6.5 cfm (corresponding to 450 ft/min velocity) and 1 ppm H₂S the impregnated activated carbon monolith showed an adsorption capacity of 4 lbs H₂S/ft³ of an adsorbent bed. The impregnated activated carbon pellets at 6.5 cfm (correponding to 75 ft/min) and 1 ppm H₂S had an adsorption capacity of 3 lbs H₂S/ft³ of an adsorbent bed. Moreover, although the velocity through the monolith was six times the velocity of the activated carbon pellet bed, the pressure drop was roughly equivalent. (See TABLE 1)

TABLE 1

| | Amount of H₂S removed |
|---|---|
| Activated Carbon Adsorbent | (lbs/per ft³ of bed) |
| Pellet impregnated with 10% Na₂CO₃ solution | 3 lbs |
| Monolith impregnated with 10% Na₂CO₃ | 4 lbs |
| solution | |

Different Alkaline Salt Impregnants

The adsorption capacity of H₂S gas was determined for the activated carbon monolith impregnated with 10% NaOH solution and compared to that of the activated carbon monolith impregnated with 10% Na₂CO₃ solution. The monolith impregnated with NaOH salt showed an adsorption capacity for H₂S gas of 6 lbs/ft³ of an adsorbent bed, while the monolith impregnated with Na₂CO₃ salt showed an adsorption capacity for H₂S gas of 4 lbs/ft³ adsorbent bed. (TABLE 2)

TABLE 2

| | Amount |
|---|---|
| | of H₂S removed |
| Activated Carbon Adsorbent | (lbs/per ft³ of bed) |
| Monolith impregnated with 10% Na₂CO₃ | 4 lbs |
| Monolith impregnated with 10% NaOH | 6 lbs |

Different Loading Levels of a Alkaline Salt Impregnant

The activation carbon monolith was impregnated with 20% Na₂CO₃ solution. Its adsorption capacity for H₂S gas was measured and compared to that of the activated carbon monolith impregnated with 10% Na₂CO₃ solution. The adsorption capacity for H₂S gas increased as the level of Na₂CO₃ impregnant loading increased. When 20% Na₂CO₃ solution was used, the impregnated activated carbon monolith showed an adsorption capacity for H₂S gas of 9 lbs/ft³ of an adsorbent bed, compared to the capacity of 4 lbs/ft³ of an adsorbent bed for monolith impregnated with 10% Na₂CO₃ solution. (TABLE 3)

TABLE 3

| | Amount |
|---|---|
| | of H₂S removed |
| Activated Carbon Adsorbent | (lbs/per ft³ of bed) |
| Monolith impregnated with 10% Na₂CO₃ solution | 4 lbs |
| Monolith impregnated with 20% Na₂CO₃ solution | 9 lbs |

Pressure Drop: Impregnated Monolith vs Impregnated Pellet

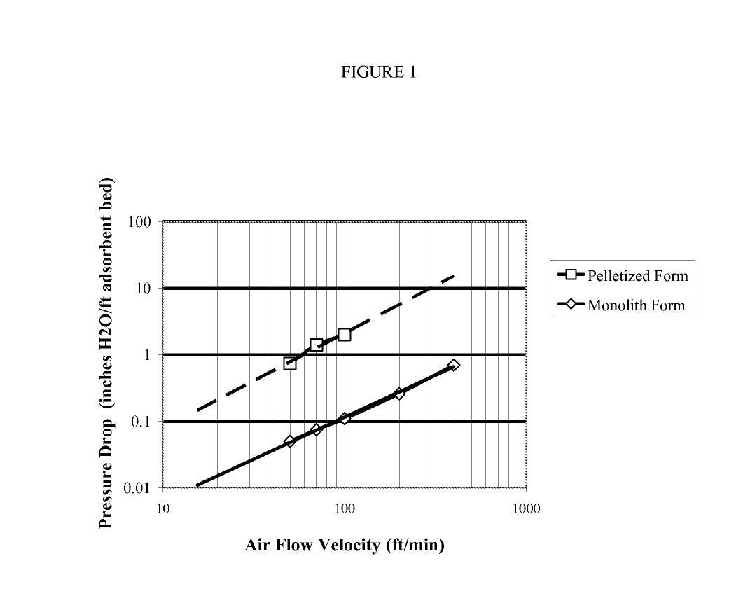

The pressure drop characteristics of the impregnated activated carbon monolith was determined and compared to those of the impregnated activated carbon pellet having the same alkaline salt impregnant and similar level of loading. The activated carbon monolith impregnated with 10% Na₂CO₃ solution showed a pressure drop of 1.8 inches H₂O/ft of an adsorbent bed. The activated carbon pellets impregnated with 10% Na₂CO₃ solution at an equivalent velocity of 450 ft/min would have showed a pressure drop exceeding 20 inches H₂O/ft of an adsorbent bed. (FIG. 1)

Mass Transfer Zone: Impregnated Monolith vs Impregnated Pellet

The mass transfer zone of the impregnated activated carbon monolith was determined and compared to that of the impregnated activated carbon pellet having the same alkaline salt impregnant and similar level of loading. The impregnated adsorbents were exposed to gas stream having a flow velocity of 100 ft/min and containing about 500 ppb of H₂S gas. The activated carbon monolith impregnated with 10% Na₂CO₃ solution showed a mass transfer zone of 2-4 inches. The activated carbon pellets impregnated with 10% Na₂CO₃ solution showed a mass transfer zone of 8-12 inches. At these conditions the pressure drop for the pellets was 2.0 inches H₂O/ft bed and the pressure drop for the monoliths was 0.1 inch H₂O/ft bed. The adsorption capacity for the monolith was 4.3 lbs H₂S/ft³ bed and the capacity of the pellets was 1.1 lbs H₂S/ft³ bed.

At an equivalent velocity, the impregnated activated carbon monolith of the present invention showed improved adsorption capacity with a shorter mass transfer zone at a substantially lower pressure drop compared to the activated carbon pellets impregnated with the same alkaline salt and at the similar loading level. This result is counter-intuitive since a bed of activated carbon pellets contains approximately 70% solid material and 30% open void volume, whereas the monolith contains approximately 30% solid material and 70% void volume. Furthermore, the tortuous flow path in a carbon pellet bed would lead to a greater opportunity for gas-solids contacting than the non-tortuous, straight channels found in an adsorbent honeycomb monolith. Additionally, the invention impregnated honeycomb may be used alone or in combination with other adsorbents for such applications.

The impregnated honeycomb of the present invention has a high adsorption capacity and low flow resistance for a variety of malodorous and harmful gaseous components. These include, but are not limited to, sulfur-containing compounds such as hydrogen sulfide, alkyl sulfide, mercaptans, dimethyl sulfide, dimethyl disulfide, and methyl mercaptan; ammonia; amines such as methylamine, dimethylamine, and trimethylamine; halogen gas such as bromine, iodine, fluorine and chlorine; aldehydes such as formaldehyde and acetaldehyde; sulfur oxides (SOx); nitrogen oxides (NOx), organic carboxylic acid such as formic acid, acetic acid, propionic acid, butyric acid and valeric acid; acidic gas such as sulfur dioxide and hydrogen chloride; esters of organic acids such as ethyl and amyl acetate; and aromatic hydrocarbons such as benzene, toluene, xylene, styrene, naphthalene, and phenol. Additionally, the invention impregnated honeycomb may be used alone or in combination with other adsorbents for such applications.

The impregnated activated carbons of the present invention have several benefits. These include, but are not limited to, enhanced impregnate loading capacity allowing for a substantial reduction in size and weight of adsorbent bed, increased removal capacity and kinetic rate of reaction, improved accessibility of the impregnant for reaction, lower pressure drop, reduced capital and maintenance cost, lower sensitivity to moisture content, enhanced fire retardant and heat dissipation, improved strength and durability, and lower dust levels compared with impregnated granular or pellets. Additionally, the invention impregnated activated carbon monoliths allow air to flow through at any angle or direction (up, down, sideways) without air bypassing or uneven pressure drop commonly realized when impregnated activated carbon granular or pellet are used. As a result, impregnated activated carbon monoliths provide improved adsorbent efficiency and flexibility in an equipment configuration design.

In corrosion protection applications using deep bed configuration, the bed velocity of the impregnated activated carbon monolith of the present invention is, at the equivalent pressure drop, up to 6 times higher than that of the impregnated activated carbon granules or pellets. Additionally, the new system design using the invention impregnated activated carbon monolith can reduce capital equipment, since the system has 6 times lower face area and does not require costly post filters, maintenance, and service costs commonly needed for conventional systems using impregnated activated carbon granules or pellets.

The impregnated activated carbon monolith of the present invention may be used in several applications. These include, but are not limited to, purification of gases and liquids such as removal of H₂S, SO₂, ethylene, ammonia, chlorine, and mercaptans; hydrotreating of fuels; corrosion protection; gas masks; production of desired chemical compounds such as hydrogenation of food oils; and removal of acidic gases and/or malodorous gases from gas streams that are common at municipal waste treatment plants, paper mills and industrial plants.

It is to be understood that the foregoing description relates to embodiments are exemplary and explanatory only and are not restrictive of the invention. Any changes and modifications may be made therein as will be apparent to those skilled in the art. Such variations are to be considered within the scope of the invention as defined in the following claims.

1. An adsorbent honeycomb monolith, comprising porous materials and at least one alkaline salt of metal, wherein the metal is selected from the group consisting of metal Group IA, metal Group IIA, and combinations thereof and wherein the alkaline salt is selected from the group consisting of hydroxide salt, carbonate salt, hydrogen carbonate salt, chlorides, bromides, fluorides, nitrates, sulfates, chlorates, carboxylates, permanganate, and combinations thereof.

2. The monolith of claim 1, wherein the porous material comprises at least one material selected from the group consisting of activated carbon, zeolite, alumina, silica, carbon black, aluminosilicates, sintered metal, zirconia, titania, and other metal oxides, and combinations thereof.

3. The monolith of claim 2, wherein a precursor of the activated carbon comprises at least one material selected from the group consisting of wood, wood dust, wood flour, cotton linters, peat, coal, coconut, lignite, carbohydrates, petroleum pitch, petroleum coke, coal tar pitch, fruit pits, fruit stones, nut shells, nut pits, sawdust, palm, vegetable, synthetic polymer, natural polymer, lignocellulosic material, and combinations thereof.

4. The monolith of claim 1, wherein the alkaline salt comprises, at least one member selected from the group consisting LiOH, NaOH, KOH, Ca(OH)₂, Mg(OH)₂, Sr(OH)₂, Ba(OH)₂, Li₂CO₃, Na₂CO₃, K₂CO₃, CaCO₃, MgCO₃, LiHCO₃, KHCO₃, KMnO₄, NaHCO₃, and combinations thereof.

5. The monolith of claim 1, wherein the monolith comprises a structure selected from the group consisting of extruded honeycomb with parallel cell passages, layered sheets with parallel passages, jelly-rolled sheets with parallel cell passages, bound aggregates of particulates with randomly distributed voidages for vapor flow, and combinations thereof.

6. The monolith of claim 1, wherein the monolith comprises a structure having geometrically uniform or non-uniform flow channels of similar, different, or random widths.

7. The monolith of claim 1, further comprising at least one supporting material for a formation or retention of the monolith structure.

8. The monolith of claim 7, wherein the supporting material comprises at least one member selected from the group consisting of ceramic, clay, cordierite, flux, glass ceramic, metal, mullite, corrugated paper, organic fibers, resin binder, talc, alumina powder, magnesia powder, silica powder, kaolin powder, sinterable inorganic powder, fusible glass powder, and combinations thereof.

9. The monolith of claim 1, wherein an amount range of the alkaline salt is from about 0.1% to about 40%: by weight of the salt based on total weight of the monolith.

10. The monolith of claim 9, wherein an amount range of the alkaline salt is from about 0.1% to about 30% by weight of the salt based on total weight of the monolith.

11. The monolith of claim 10, wherein an amount range of the alkaline salt is from about 0.1% to about 20% by weight of the salt based on total weight of the monolith.

12. The monolith of claim 1, wherein the monolith has a cell density range of from 1 cells/in² to about 1500 cells/in.

13. The monolith of claim 1, wherein the monolith has a nitrogen B.E.T. surface area range of about 200 m²/g to about 3000 m²/g.

14. The monolith of claim 13, wherein the monolith has a nitrogen B.E.T. surface area range of about 600 m²/g to about 2500 m²/g.

15. The monolith of claim 14, wherein the monolith has a nitrogen B.E.T. surface area range of about 1000 m²/g to about 1600 m²/g.

16. The monolith of claim 1, wherein an adsorbent bed containing the monolith has a pressure drop in a range of about 0.01 to about 10 inches H₂O/ft of the bed and an H₂S adsorption capacity of at least 4 lbs/ft³ of the bed when an air flow velocity through the bed is about 450 ft/min.

17. The monolith of claim 16, wherein an adsorbent bed containing the monolith has a pressure drop in a range of about 0.01 to about 5 inches H₂O/ft of the bed and an H₂S adsorption capacity of at least 4 lbs/ft³ of the bed when an air flow velocity through the bed is about 450 ft/min.

18. The monolith of claim 17, wherein an adsorbent bed containing the monolith has a pressure drop in a range of about 0.01 to about 2 inches H₂O/ft of the bed and an H₂S adsorption capacity of at least 4 lbs/ft³ of the bed when an air flow velocity through the bed is about 450 ft/min.

19. A gas treating apparatus, including a gas passageway extending from a gas inlet to a gas outlet and an adsorbent bed containing impregnated monolith disposed in the passageway, wherein the monolith comprises an adsorbent honeycomb monolith impregnated with at least one alkaline salt of metal, wherein the metal is selected from the group consisting of metal Group IA, metal Group IIA, and combinations thereof and wherein the alkaline salt hydroxide salt, carbonate salt, hydrogen carbonate salt, chlorides, bromides, fluorides, nitrates, sulfates, chlorates, carboxylates, permanganate, and combinations thereof.

20. The apparatus of claim 19, wherein the porous monolith comprises at least one material selected from the group consisting of activated carbon, zeolite, alumina, silica, carbon black, aluminosilicates, sintered metal, and combinations thereof.

21. The apparatus of claim 20, wherein a precursor of the activated carbon comprises at least one material selected from the group consisting of wood, wood dust, wood flour, cotton linters, peat, coal, coconut, lignite, carbohydrates, petroleum pitch, petroleum coke, coal tar pitch, fruit pits, fruit stones, nut shells, nut pits, sawdust, palm, vegetable, synthetic polymer, and natural polymer, lignocellulosic material, and combinations thereof.

22. The apparatus of claim 19, wherein the alkaline salt comprises at least one member selected from the group consisting LiOH, NaOH, KOH, Ca(OH)₂, Mg(OH)₂, Sr(OH)₂, Ba(OH)₂, Li₂CO₃, Na₂CO₃, K₂CO₃, CaCO₃, MgCO₃, LiHCO₃ KHCO₃, KMnO₄, NaHCO3, and combinations thereof.

23. The apparatus of claim 19, wherein the monolith comprises a structure selected from the group consisting of extruded honeycomb with parallel cell passages, layered sheets with parallel passages, jelly-rolled sheets with parallel cell passages, bound aggregates of particulates with randomly distributed voidages for vapor flow, and combinations thereof.

24. The apparatus of claim 19, wherein the monolith comprises a structure having geometrically uniform or non-uniform flow channels of similar, different, or random widths.

25. The apparatus of claim 19, wherein the monolith further comprises at least one supporting material for a formation or retention of the monolith structure.

26. The apparatus of claim 25, wherein the supporting material comprises at least one member selected from the group consisting of ceramic, clay, cordierite, flux, glass ceramic, metal, mullite, corrugated paper, organic fibers, resin binder, talc, alumina powder, magnesia powder, silica powder, kaolin powder, sinterable inorganic powder, fusible glass powder, and combinations thereof.

27. The apparatus of claim 19, wherein an amount range of the alkaline salt is from about 0.1% to about 40% by weight of metal salt based on total weight of the monolith.

28. The apparatus of claim 27, wherein an amount range of the alkaline salt is from about 0.1% to about 30% by weight of metal salt based on total weight of the monolith.

29. The apparatus of claim 28, wherein an amount range of the alkaline salt is from about 0.1% to about 20% by weight of metal salt based on total weight of the monolith.

30. The apparatus of claim 19, wherein the monolith has a cell density range of from 1 cells/in² to about 1500 cells/in².

31. The apparatus, of claim 19, wherein the monolith has a nitrogen B.E.T. surface area range of about 200 m²/g to about 3000 m²/g.

32. The apparatus of claim 31, wherein the monolith has a nitrogen B.E.T. surface area range of about 600 m²/g to about 2500 m²/g.

33. The apparatus of claim 32, wherein the monolith has a nitrogen B.E.T. surface area range of about 1000 m²/g to about 1600 m²/g.

34. The apparatus of claim 19, wherein the adsorbent bed has a pressure drop in a range of about 0.01 to about 10 inches H₂O/ft of the bed and an H₂S adsorption capacity of at least 4 lbs/ft³ of the bed when an air flow velocity through the bed is about 450 ft/min.

35. The apparatus of claim 34, wherein the adsorbent bed has a pressure drop in a range of about 0.01 to about 5 inches H₂O/ft of the bed and an H₂S adsorption capacity of at least 4 lbs/ft³ of the bed when an air flow velocity through the bed is about 450 ft/min.

36. The apparatus of claim 35, wherein the adsorbent bed has a pressure drop in a range of about 0.01 to about 2 inches H₂O/ft of the bed and an H₂S adsorption capacity of at least 4 lbs/ft³ of the bed when an air flow velocity through the bed is about 450 ft/min.

37. The apparatus of claim 19, wherein the gas comprises at least one member selected from the group consisting of hydrogen sulfide, alkyl sulfide, mercaptans, dimethyl sulfide, dimethyl disulfide, methyl mercaptan, ammonia, amines, bromine, iodine, fluorine, chlorine, aldehydes, sulfur oxides (SOx), nitrogen oxides (NOx), organic carboxylic acid, acidic gas, hydrogen chloride, hydrogen bromide, hydrogen fluorine, sulfur dioxide, BCl₃, BF₃, AsCl₃, PCl3, PF₃, GeF₄, AsF₅, SiF₄, SiBr₄, COF₂, esters of organic acid, aromatic hydrocarbon, and combinations thereof.

38. A method of treating gas, including a step of contacting the treated gas with impregnated monolith comprising porous monolith and at least one alkaline salt of metal, wherein the metal is selected from the group consisting of metal Group IA, metal Group IIA, and combinations thereof and wherein the alkaline salt is at least one member selected from the group consisting of hydroxide salt, carbonate salt, hydrogen carbonate salt, chlorides, bromides, fluorides, nitrates, sulfates, chlorates, carboxylates, permanganate, and combinations thereof.

39. The method of claim 38, wherein the porous monolith comprises at least one material selected from the group consisting of activated carbon, zeolite, alumina, silica, carbon black, alumina silicates, sintered metal, and combinations thereof.

40. The method of claim 39, wherein a precursor of the activated carbon comprises at least one material selected from the group consisting of wood, wood dust, wood flour, cotton linters, peat, coal, coconut, lignite, carbohydrates, petroleum pitch, petroleum coke, coal tar pitch, fruit pits, fruit stones, nut shells, nut pits, sawdust, palm, vegetable, synthetic polymer, and natural polymer, lignocellulosic material, and combinations thereof.

41. The method of claim 38, wherein the alkaline salt comprises at least one member selected from the group consisting LiOH, NaOH, KOH, Ca(OH)₂, Mg(OH)₂, Sr(OH)₂, Ba(OH)₂, Li₂CO₃, Na₂CO₃, K₂CO₃, CaCO₃, MgCO₃, LiHCO₃, KHCO₃, KMnO₄, NaHCO₃, and combinations thereof.

42. The method of claim 38, wherein the monolith comprises a structure selected from the group consisting of extruded honeycomb with parallel cell passages, layered sheets with parallel passages, jelly-rolled sheets with parallel cell passages, bound aggregates of particulates with randomly distributed voidages for vapor flow, and combinations thereof.

43. The method of claim 38, wherein the monolith comprises a structure having geometrically uniform or non-uniform flow channels of similar, different, or random widths.

44. The method of claim 38, wherein the monolith further comprises at least one supporting material for a formation or retention of the monolith structure.

45. The method of claim 44, wherein the supporting material comprises at least one member selected from the group consisting of ceramic, clay, cordierite, flux, glass ceramic, metal, mullite, corrugated paper, organic fibers, resin binder, talc, alumina powder, magnesia powder, silica powder, kaolin powder, sinterable inorganic powder, fusible glass powder, and combinations thereof.

46. The method of claim 38, wherein an amount range of the alkaline salt is from about 0.1% to about 40% by weight of metal salt based on total weight of the monolith.

47. The method of claim 46, wherein an amount range of the alkaline salt is from about 0.1% to about 30% by weight of metal salt based on total weight of the monolith.

48. The method of claim 47, wherein an amount range of the alkaline salt is from about 0.1% to about 20% by weight of metal salt based on total weight of the monolith.

49. The method of claim 38, wherein the monolith has a cell density range of from 1 cells/in² to about 1500 cells/in².

50. The method of claim 38, wherein the monolith has a nitrogen B.E.T. surface area range of about 200 m²/g to about 3000 m²/g.

51. The method of claim 50, wherein the monolith has a nitrogen B.E.T. surface area range of about 600 m²/g to about 2500 m²/g.

52. The method of claim 51, wherein the monolith has a nitrogen B.E.T. surface area range of about 1000 m²/g to about 1600 m²/g.

53. The method of claim 38, wherein an adsorbent bed containing the monolith has a pressure drop in a range of about 0.01 to about 10 inches H₂O/ft of the bed and an H₂S adsorption capacity of at least 4 lbs/ft³ of the bed when an air flow velocity through the bed is about 450 ft/min.

54. The method of claim 53, wherein an adsorbent bed containing the monolith has a pressure drop in a range of about 0.01 to about 5 inches H₂O/ft of the bed and an H₂S adsorption capacity of at least 4 lbs/ft³ of the bed when an air flow velocity through the bed is about 450 ft/min.

55. The method of claim 54, wherein an adsorbent bed containing the monolith has a pressure drop in a range of about 0.01 to about 2 inches H₂O/ft of the bed and an H₂S adsorption capacity of at least 4 lbs/ft³ of the bed when an air flow velocity through the bed is about 450 ft/min.

56. The method of claim 38, wherein the gas comprises at least one member selected from the group consisting of hydrogen sulfide, alkyl sulfide, mercaptans, dimethyl sulfide, dimethyl disulfide, methyl mercaptan, ammonia, amines, bromine, iodine, fluorine, chlorine, aldehydes, sulfur oxides (SOx), nitrogen oxides (NOx), organic carboxylic acid, acidic gas, hydrogen chloride, hydrogen bromide; hydrogen fluorine, sulfur dioxide, BCl₃, BF₃, AsCl₃, PCl3, PF₃, GeF₄, AsF₅, SiF₄, SiBr₄, COF₂, esters of organic acid, aromatic hydrocarbon, and combinations thereof.

57. A porous monolith, comprising porous material and at least one chemical selected from the group consisting of Rankinite, Rankinite A, silver, mercury, iodic acid, whetlerite, and combinations thereof.

58. The monolith of claim 57, wherein the whetlerite comprises at least one member selected from the group consisting of whetlerite Type A, Type B, Type AS, Type D, Type A impregnated with Hexamine, Type A impregnated with sodium thiocyanate, Type ASM, Type ASV, Type ASMT, Type ASC, Type ASCM, Type ASVT, Type ASC-1, Type Barnebey-Cheney, Type ASCP, Type ASCPi, Type E11, Type PCI, Type ASZM, Type ASZM-TEDA, Type ASC-TEDA, and combinations thereof.

59. The monolith of claim 57, wherein the porous material comprises at least one material selected from the group consisting of activated carbon, zeolite, alumina, silica, carbon black, alumino silicates, sintered metal, and combinations thereof.

60. The monolith of claim 58, wherein a precursor of the activated carbon comprises at least one material selected from the group consisting of wood, wood dust, wood flour, cotton linters, peat, coal, coconut, lignite, carbohydrates, petroleum pitch, petroleum coke, coal tar pitch, fruit pits, fruit stones, nut shells, nut pits, sawdust, palm, vegetable, synthetic polymer, natural polymer, lignocellulosic material, and combinations thereof.

61. The monolith of claim 57, further comprising at least one supporting material for a formation or retention of the monolith structure.

62. The monolith of claim 61, wherein the supporting material comprises at least one member selected from the group consisting of ceramic, clay, cordierite, flux, glass ceramic, metal, mullite, corrugated paper, organic fibers, resin binder, talc, alumina powder, magnesia powder, silica powder, kaolin powder, sinterable inorganic powder, fusible glass powder, and combinations thereof.

63. A gas treating apparatus, including a gas passageway extending from a gas inlet to a gas outlet and an adsorbent bed containing impregnated monolith disposed in the passageway, wherein the monoliths comprises porous monolith and at least one chemical selected from the group consisting of Rankinite, Rankinite A, silver, mercury, iodic acid, whetlerite, and combinations thereof.

64. The apparatus of claim 63, wherein the whetlerite comprises at least one member selected from the group consisting of whetlerite Type A, Type B, Type AS, Type D, Type A impregnated with Hexamine, Type A impregnated with sodium thiocyanate, Type ASM, Type ASV, Type ASMT, Type ASC, Type ASCM, Type ASVT, Type ASC-1, Type Barnebey-Cheney, Type ASCP, Type ASCPi, Type E11, Type PCI, Type ASZM, Type ASZM-TEDA, Type ASC-TEDA, and combination thereof.

65. The apparatus of claim 63, wherein the porous monolith comprises at least one material selected from the group consisting of activated carbon, zeolite, alumina, silica, carbon black, alumino silicates, sintered metal, and combinations thereof.

66. The apparatus of claim 65, wherein a precursor of the activated carbon comprises at least one material selected from the group consisting of wood, wood dust, wood flour, cotton linters, peat, coal, coconut, lignite, carbohydrates, petroleum pitch, petroleum coke, coal tar pitch, fruit pits, fruit stones, nut shells, nut pits, sawdust, palm, vegetables synthetic polymer, and natural polymer, lignocellulosic material, and combinations thereof.

67. The apparatus of claim 63, wherein the monolith further comprises at least one supporting material for a formation or retention of the monolith structure.

68. The apparatus of claim 67, wherein the supporting material comprises at least one member selected from the group consisting of ceramic, clay, cordierite, flux, glass ceramic, metal, mullite, corrugated paper, organic fibers, resin-binder, talc, alumina powder, magnesia powder, silica powder, kaolin powder, sinterable inorganic powder, fusible glass powder, and combinations thereof.

69. The apparatus of claim 63, wherein the gas comprises at least one member selected from the group consisting of acyl chlorides, amines, ammonia, arsine, carbon monoxide, chloropicrin, cyanogen chloride, hydrogen cyanide, fluoride, fluorophosphate, mustard gas, nitrogen dioxide, phosgene, sulfur dioxide, Saran, VX, DMMP, and combinations thereof.

70. A method of treating gas, including a step of contacting the treated gas with impregnated monoliths comprising porous monolith and at least and at least one chemical selected from the group consisting of Rankinite, Rankinite A, silver, mercury, iodic acid, whetlerite, and combinations thereof.

71. The method of claim 70, wherein the whetlerite, comprises at least one member selected from the group consisting of whetlerite Type A, Type B, Type AS, Type D, Type A impregnated with Hexamine, Type A impregnated with sodium thiocyanate, Type ASM, Type ASV, Type ASMT, Type ASC, Type ASCM, Type. ASVT, Type ASC-1, Type Barnebey-Cheney, Type ASCP, Type ASCPi, Type E11, Type PCI, Type ASZM, Type ASZM-TEDA, Type ASC-TEDA, and combination thereof.

72. The method of claim 70, wherein the porous monolith comprises at least one material selected from the group consisting of activated carbon, zeolite, alumina, silica, carbon black, alumino silicates, sintered metal, and combinations thereof.

73. The method of claim 71, wherein a precursor of the activated carbon comprises at least one material selected from the group consisting of wood, wood dust, wood flour, cotton linters, peat, coal, coconut, lignite, carbohydrates, petroleum pitch, petroleum coke, coal tar pitch, fruit pits, fruit stones, nut shells, nut pits, sawdust, palm, vegetable, synthetic polymer, and natural polymer, lignocellulosic material, and combinations thereof.

74. The method of claim 70, wherein the monolith further comprises at least one supporting material for a formation or retention of the monolith structure.

75. The method of claim 74, wherein the supporting material comprises at least one member selected from the group consisting of ceramic, clay, cordierite, flux, glass ceramic, metal, mullite, corrugated paper, organic fibers, resin binder, talc, alumina powder, magnesia powder, silica powder, kaolin powder, sinterable inorganic powder, fusible glass powder, and combinations thereof.

76. The method of claim 70, wherein the gas comprises at least one member selected from the group consisting of acyl chlorides, amines, ammonia, arsine, carbon monoxide, chloropicrin, cyanogen chloride, hydrogen cyanide, fluoride, fluorophosphate, mustard gas, nitrogen dioxide, phosgene, sulfur dioxide, Saran, VX, DMMP, and combinations thereof.
